(19) United States
(12) Patent Application Publication
(10) Pub. No.: US 2006/0138770 A1
(43) Pub. Date: Jun. 29, 2006

(54) Connecting pipe

(76) Inventors: Atsuo Miyajima, Inuyama-shi (JP); Koji Shimizu, Nagoya-shi (JP)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/315,747

(22) Filed: Dec. 22, 2005

(30) Foreign Application Priority Data
Dec. 24, 2004 (JP) 2004-374799
Dec. 16, 2005 (JP) 2005-364134

(51) Int. Cl. F16L 33/00

(52) U.S. Cl. 285/239

(57) ABSTRACT

A rigid connecting pipe to be securely fixed in a rubber hose by press-fitting has a pipe body and an annular rib on a leading end portion of the pipe body. The annular rib has a generally saw-edged cross-section and is formed in an acute angled shape. The annular rib serves as a stopper relative to the rubber hose by biting in an inner surface of the rubber hose. The connecting pipe further has a tubular support portion on a leading end thereof beyond the annular rib. The support portion supports the rubber hose from an inner surface side thereof, on a leading end beyond the annular rib while being press-fitted in the rubber hose.

### BACKGROUND OF THE INVENTION

1. Field of the Invention

The present invention relates to a rigid connecting pipe to be securely fixed to a rubber hose by means of press-fitting.

2. Description of the Related Art

Previously, a resin hose or a rubber hose is used for transporting various fluids.

In case of the latter rubber hose, a fixing structure of a connecting pipe to the rubber hose as shown in FIG. 6 has been typically used for a piping.

In this fixing structure, a rigid connecting pipe 204 is formed with a bulge portion 202. The connecting pipe 204 is press-fitted or force-fitted in the rubber hose 200, a hose end portion 200A is fastened by a hose clamp 206 on an outer peripheral surface thereof on the connecting pipe 204, and thereby the rubber hose 200 is fixed to the connecting pipe 204 to provide a stop relative to the connecting pipe 204.

However, this fixing structure entails a problem that the hose clamp 206 is required as a part for securely fixing the connecting pipe 204 to the rubber hose 200, and number of man-hour for fixing work is increased.

On the other hand, another fixing structure for fixing a connecting pipe to a rubber hose without fastening of a hose clamp is proposed in Patent Document 1 below.

FIG. 7 shows a specific example of this fixing structure.

In FIG. 7, reference numeral 208 is a T-joint, and connecting pipes 204 extend in three directions.

Each of the connecting pipes 204 is provided with annular ribs 210 at a plurality of axial positions thereof. The annular rib 210 has a generally saw-edged cross-section and is formed in an acute angled shape. Such annular ribs 200 serve as stoppers relative to a rubber hose 200 by biting in an inner surface of the rubber hose 200.

Here, each of the annular ribs 210 includes a guide surface 211 on a leading and press-fitted end thereof that is tapered to guide the rubber hose 200 during press-fitting.

In this fixing structure, the connecting pipe 204 is press-fitted within the rubber hose 200 while diametrically enlarging a hose end portion 200A, and is securely fixed in or to the rubber hose 200.

Each of the connecting pipes 204 that is press-fitted in the rubber hose 200 is stopped relative to the rubber hose 200 in such manner that the annular ribs 210 bite in the inner surface of the rubber hose 200.

FIG. 8(a) is a view showing a method for press-fitting the connecting pipe 204 in the rubber hose 200 mechanically and fixing it in the rubber hose 200 in the fixing structure of FIG. 7. While the rubber hose 200 is held by a hose chuck 212 (the hose chuck 212 is schematically shown in the figures), the connecting pipe 204 is press-fitted in the hose end portion 200A by a press-fitting jig 214, and securely fixed in or to the rubber hose 200. Construction of the connecting pipe 204 shown in FIG. 8 is slightly different from the one shown in FIG. 7.

In case of the fixing structure shown in FIG. 7, the rubber hose 200 is not fastened by the hose clamp 206, it is necessary that a press-fitting force of the connecting pipe 204 to the rubber hose 200 is increased, namely, it is necessary that the connecting pipe 204 is press-fitted in the rubber hose 200 while diametrically enlarging the hose end portion 200A largely, in order to obtain a sufficient fixing force.

In this case, when a diameter of the rubber hose 200 is relatively small, the press-fitting force is not required to be so large. And, it is possible for an operator to press-fit the connecting pipe 204 in the rubber hose 200 while making a delicate adjustment by hand.

However, when the diameter of the rubber hose 200 is larger than a certain length, required press-fitting force is increased, and it becomes impossible for the operator to press-fit the connecting pipe 204 in the rubber hose 200 by hand.

Then, it is required to press-fit the connecting pipe 204 in the rubber hose 200 mechanically with use of the hose chuck 212 and the press-fitting jig 214 as shown in FIG. 8.

However, even in the rubber hose 200 that has a large diameter, usually its wall-thickness is not great that much. On the other hand, the connecting pipe 204 is press-fitted in the rubber hose 200 under a large press-fitting force, and the operator cannot make a delicate adjustment during mechanical press-fitting, different from the case of press-fitting by hand. So, as shown in FIGS. 9(a), 9(b), the rubber hose 200 is buckled during press-fitting, and there exists a problem that the connecting pipe 204 is not is favorably press-fitted in the rubber hose 200.

For example, a heater hose (a hose for introducing a water warmed by an engine to a heater for warming a vehicle interior) to be arranged in a vehicle is a relatively small diameter hose having an inner diameter from 13 to 16 mm (a wall-thickness t is about 3 to 4 mm). In such case, it is possible to press-fit the connecting pipe 204 in the rubber hose (the heater hose) 200 without causing buckling of the rubber hose 200, and to securely fix the connecting pipe 204 in the rubber hose 200.

On the contrary, for example, a radiator hose (a hose for communicating between the engine and a radiator) is a large diameter hose having an inner diameter of about 30 to 35 mm (a wall-thickness t is about 3.5 to 4.5 mm). In case of such rubber hose having a large diameter or having a ratio of a wall-thickness to an outer diameter up to 0.15, the press-fitting force of the connecting pipe 204, namely a resisting force to or of the rubber hose 200 during press-fitting is increased. On the other hand, as the wall-thickness is not so great and in addition, strength (rigidity or stiffness) of the rubber hose 200 is relatively decreased by forming the rubber hose 200 with a large diameter, the rubber hose 200 tends to be buckled as above, and it becomes difficult to favorably press-fit the connecting pipe 204 in the rubber hose 200.

And, a rubber hose having a reinforcing layer is subject to or is provided with an increased resisting force during press-fitting, and tends to be buckled more easily.

[Patent Document 1] JP-A, 2000-65270

Under the circumstances described above, it is an object of the present invention to provide a connecting pipe preventing a rubber hose from buckling during press-fitting, and being favorably press-fitted in the rubber hose.

### SUMMARY OF THE INVENTION

According to the present invention, there is provided a novel connecting pipe with rigidity to be securely fixed in a rubber hose by press-fitting. The connecting pipe comprises a pipe body, and an annular rib provided at least on a leading end portion of the pipe body. The connecting pipe according to the present invention has a tubular support portion formed on a leading end or a leading end portion of the pipe body. The tubular support portion is arranged on a leading end or a leading side beyond the annular rib. The annular rib has a generally saw-edged cross-section and is formed in an acute angled shape. The annular rib is provided with a guide surface on a leading and press-fitted end or on a front end of the annular rib to guide the rubber hose during press-fitting. That is, the annular rib is provided with a guide surface facing a leading direction or facing front to guide the rubber hose during press-fitting. The annular rib serves as a stopper relative to the rubber hose by biting in an inner surface of the rubber hose. The support portion supports the rubber hose in a radially outer side from an inner surface side thereof, on a leading end beyond the annular rib while being press-fitted in the rubber hose. The rubber hose may have an inner diameter, for example, larger than 16 mm. The support portion may be formed to have an outer diameter equal to or smaller than an inner diameter of the rubber horse, or may be formed to have an outer diameter larger than the inner diameter of the rubber hose.

In the connecting pipe according to the present invention, the support portion may be projecting or extending in an axial direction for a length equal to or greater than a wall-thickness of the rubber hose.

The connecting pipe according to the present invention may be constructed such that the connecting pipe is press-fitted in the rubber hose and is securely fixed to the rubber hose not by a hose clamp, but only by press-fitting. Here, the hose clamp is omitted.

The rubber hose is, for example, a large-diameter rubber hose having an inner diameter larger than 16 mm.

In the rubber hose, a reinforcing yarn may be provided. A staple yarn, a spunnized or spunized yarn or a dip yarn may be adapted for the reinforcing yarn.

As stated above, according to the present invention, the tubular support portion is formed on the leading end of the connecting pipe or the pipe body, and arranged on a leading end beyond the annular rib or relative to the annular rib. The annular rib has the generally saw-edged cross-section and is formed in an acute angled shape. The support portion supports the rubber hose in the radially outer side from the inner surface side thereof while being press-fitted in the rubber hose. In the present invention, when the connecting pipe is press-fitted in the rubber hose against its resisting force while diametrically enlarging the end portion of the rubber hose, the tubular support portion on the leading end or leading edge of the pipe body supports the rubber hose from the inner surface side on a leading end beyond the annular rib. Thereby the rubber hose may be prevented favorably from being buckled and the connecting pipe may be favorably press-fitted in the rubber hose. The outer diameter of the support portion may be designed equal to or smaller than the inner diameter of the rubber hose. Thereby such trouble with press-fitting may be avoided that when the connecting pipe is press-fitted in the rubber hose, an end of the rubber hose abuts a leading edge of the support portion, and is folded inwardly. Or the outer diameter of the support portion may be designed larger than or slightly larger than the inner diameter of the rubber hose. And, for example, supporting function of the support portion may be thereby enhanced. In case where the outer diameter of the support portion is designed larger than the inner diameter of the rubber hose, a difference between the outer diameter of the support portion and the inner diameter of the rubber hose may be designed, for example, one-twentieth to a quarter of the wall-thickness of the rubber hose. That is, the outer diameter of the support portion may be designed larger than the inner diameter of the rubber hose by one-twentieth or a quarter of the wall-thickness of the rubber hose.

In the present invention, the support portion projects or extends in an axial direction preferably, for example, for a length equal to or greater than the wall-thickness of the rubber hose.

The present invention is specifically suitably adapted for a case where the connecting pipe is securely fixed in the rubber hose by press-fitting without a hose clamp, when the connecting pipe is press-fitted in the rubber hose.

The present invention is specifically effectively adapted for a case where the connecting pipe is press-fitted and securely fixed in a large-diameter rubber hose that has an inner diameter larger than 16 mm, for example, an inner diameter of 25 to 45 mm.

It is effective to construct a reinforcing structure where displacement of its yarn is prevented by providing in the rubber hose a reinforcing yarn or thread that has an anchor effect relative to the rubber hose like a staple yarn, a spunnized yarn or a dip yarn (or a reinforcing layer formed from such reinforcing yarn or thread).

An advantage of this construction will be clear in the following description. The connecting structure of the connecting pipe to the rubber hose is required to have both an ease of press-fitting (press-fit performance) of the connecting pipe and a sealing property (sealing performance) between the connecting pipe and the rubber hose. FIG. 10 shows a relationship of a diametrically enlarging rate and a sealing performance, in a rubber hose including a dip yarn (a reinforcing yarn dipped in a solution for surface treatment such as RFL) as a reinforcing yarn and a rubber hose including an ordinary yarn (a reinforcing yarn not subject to a treatment such as surface treatment) as a reinforcing yarn. As understood from FIG. 10, the rubber hose including the dip yarn is superior to the rubber hose including the ordinary yarn in the sealing performance under the same condition of a diametrically enlarging rate of the rubber hose. Here, the diametrically enlarging rate (%)=((an inner diameter of the rubber hose after diametrically enlarged−an inner diameter thereof before diametrically enlarged)/the inner diameter thereof before diametrically enlarged)×100. Namely, the rubber hose including the dip yarn may achieve a sealing performance equivalent to the rubber hose including the ordinary yarn under smaller diametrically enlarging rate. And, the press-fit performance of the connecting pipe relative to the rubber hose is improved as far as the diametrically enlarging rate is small. For example, as explained in Table 1 (Table 1 explains the press-fit performance and the sealing performance when the diametrically enlarging rate is varied), in the rubber hose including the dip yarn (for example, when a reinforcing layer is formed from the dip yarn), a good sealing performance is achieved under a diametrically enlarging rate of 15%. On the other hand, in the rubber hose including the ordinary yarn (for example, when a reinforcing layer is formed from the ordinary yarn), a satisfactory sealing performance is not be achieved until the diametrically enlarging rate is increased to 30%. This is thanks to an anchor effect of the dip yarn relative to the rubber hose.

Namely, as the rubber hose is diametrically enlarged, the reinforcing yarn provided or embedded in the rubber hose is likely to be moved. When the rubber hose is further diametrically enlarged, breakage of the yarn is caused, and thereby the sealing performance is extremely lowered. However, the anchor effect of the dip yarn relative to the rubber hose prevents or restrains the dip yarn from movement, and as a result, an excellent sealing performance may be secured.

Meanwhile, in FIG. 10, once the diametrically enlarging rate is increased to a certain value, the sealing performance of the rubber hose including the ordinary yarn remains constant, and is no more increased when the diametrically enlarging rate is further increased. The reason is that the sealing performance is not improved due to displacement of the ordinary yarn.

And, as shown in Table 2 (Table 2 explains the press-fit performance and the sealing performance at varied braid angles under a certain diametrically enlarging rate of the rubber hose), in a reinforcing layer formed by braiding the reinforcing yarn, specifically the dip yarn, favorable press-fit performance and sealing performance may be ensured in a wide range of braid angles of 45° to 55°. This basically applies to a reinforcing layer formed by spirally winding the reinforcing yarn.

In the reinforcing layer formed from the dip yarn, an adhesive effect with a rubber produces a large reinforcing effect relative to the rubber hose, and may effectively restrain a change of an outer diameter of the rubber hose. As a result, in the reinforcing layer formed from the dip yarn, the change of the outer diameter of the rubber hose may be restrained even at a small braid angle of the reinforcing yarn and the sealing performance is good widely in a range of the braid angle wherein the press-fit performance of the rubber hose is good. In Table 1 and Table 2, when the press-fitting of the connecting pipe cannot be conducted, judgement of the sealing performance is indicated with a symbol “—”.

On the other hand, in the reinforcing layer formed from the ordinary yarn, as the ordinary yarn is likely to be moved relative to the rubber, an outer diameter of the rubber hose tends to be largely changed, and thereby the sealing performance thereof is inferior compared to that of the rubber hose having the reinforcing layer formed from the dip yarn. Therefore, the braid angle is required to be designed high in order to secure the sealing performance. However, when the braid angle is designed high, the press-fit performance in the rubber hose is deteriorated. In the worst case, there is a possibility that displacement of the yarn or breakage of the yarn is caused and the reinforcing effect relative to the rubber hose is lowered and so on. So, the range of the braid angle of the reinforcing yarn or the ordinary yarn must be controlled narrow.

By the way, instead of the dip yarn, a staple yarn or partly stretch broken filament (spunnized yarn) may be used to fluff a surface of the reinforcing layer, and thereby a friction force between the rubber hose and the reinforcing layer is increased or the anchor effect of the reinforcing layer relative to the rubber hose is improved. As a result, the same effect may be obtained. Or, applicable are other means for improving the friction force relative to the rubber. Namely, a contact area of the reinforcing layer with the rubber may be increased by decreasing a thread count (number of thread) of the reinforcing yarn, the anchor effect of the reinforcing layer relative to the rubber may be increased, on the contrary by increasing a thread count (number of thread) of the reinforcing yarn, or further, the contact area with the rubber may be increased by increasing number of denier of the reinforcing yarn. These means also produce effects equivalent in the case of the reinforcing layer formed from the dip yarn or the like.

TABLE 1
Diametrically enlarging rate (%)

| | | 10 | 15 | 20 | 25 | 30 | 35 |
|---|---|---|---|---|---|---|---|
| Dip Yarn | Press-fit | ∘ | ∘ | ∘ | ∘ | ∘ | x |
| | performance | | | | | | |
| | Sealing | x | ∘ | ∘ | ∘ | ∘ | — |
| | performance | | | | | | |
| Ordinary | Press-fit | ∘ | ∘ | ∘ | ∘ | ∘ | ∘ |
| yarn | performance | | | | | | |
| | Sealing | x | x | x | x | ∘ | x |
| | performance | | | | | | |

Note
The symbol “∘” means “good”.
The symbol “x” means “no good”.
The symbol “—” means “measurement disabled”

TABLE 2
Braid angle (degrees)

| | | 40 | 45 | 50 | 55 | 60 |
|---|---|---|---|---|---|---|
| Dip | Press-fit | ∘ | ∘ | ∘ | ∘ | x |
| yarn | performance | | | | | |
| | Sealing | x | ∘ | ∘ | ∘ | — |
| | performance | | | | | |
| Ordinary | Press-fit | ∘ | ∘ | ∘ | ∘ | ∘ |
| yarn | performance | | | | | |
| | Sealing | x | x | x | ∘ | x |
| | performance | | | | | |

Note
The symbol “∘” means “good”.
The symbol “x” means “no good”.
The symbol “—” means “measurement disabled”

Now, the preferred embodiments of the present invention will be described in detail with reference to the drawings.

### BRIEF DESCRIPTION OF THE DRAWINGS

FIG. 1 is a sectional view showing a connecting pipe according to one embodiment of the present invention, which is press-fitted and securely fixed in a rubber hose.

FIG. 2 is a sectional view showing the connecting pipe and the rubber hose of FIG. 1 in a state before the connecting pipe is press-fitted and securely fixed in the rubber hose.

FIG. 3 is a perspective view showing the connecting pipe and the rubber hose in the state of FIG. 2.

FIG. 4(a) is an explanatory view of an action of a support portion during press-fitting of the connecting pipe in the rubber hose, and showing a state at start of press-fitting.

FIG. 4(b) is an explanatory view of the action of the support portion during press-fitting of the connecting pipe in the rubber hose, and showing a state in press-fitting process.

FIG. 4(c) is an explanatory view of the action of the support portion during press-fitting of the connecting pipe in the rubber hose, and showing a state at start of press-fitting in case where an outer diameter of the support portion is made larger than an inner diameter of the rubber hose.

FIG. 5 is an explanatory view for explaining the action of the support portion in FIGS. 1 to 3 in view of a relationship with a wall-thickness of the rubber hose.

FIG. 6 is a view of an example of a conventional connecting pipe that is connected to a rubber hose.

FIG. 7 is a view of an example of a conventional connecting pipe other than the one of FIG. 6.

FIG. 8(a) is a view showing a fixing method of the connecting pipe of FIG. 7.

FIG. 8(b) is a sectional view showing a hose chuck.

FIG. 9(a) is an explanatory sectional view showing buckling of the rubber hose.

FIG. 9(b) is an explanatory perspective view showing buckling of the rubber hose.

FIG. 10 is a chart for explaining a relationship between a sealing performance and a diametrically enlarging rate according to a type of reinforcing yarn.

### DETAILED DESCRIPTION OF THE PREFERRED EMBODIMENTS

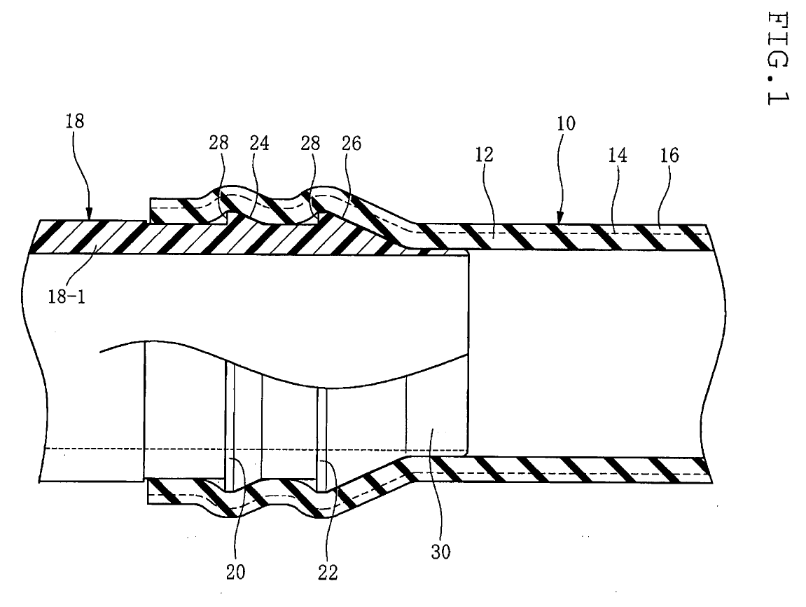

In FIG. 1, reference numeral 10 is a rubber hose (here, a radiator hose) having a multilayered construction including an inner surface rubber layer 12, a fiber reinforcing layer 14 and an outer surface rubber layer 16.

Reference numerals 18, 18-1 indicate a rigid connecting pipe, a rigid pipe body (here, made of resin, but may be made of metal). The connecting pipe 18 serves as a joint member for a piping. The connecting pipe 18 is provided with a plurality of annular ribs (here, two annular ribs) 20, 22 along an axial direction of the connecting pipe 18 or the pipe body 18-1. Each of the annular ribs 20, 22 has a generally saw-edged cross-section and is formed in an acute angled shape.

The annular ribs 20, 22 are portions to serve as stoppers relative to the rubber hose 10 by biting in an inner surface of the rubber hose 10 after the connecting pipe 18 is press-fitted in the rubber hose 10.

In this embodiment, one annular rib 22 is provided on a leading end portion of the connecting pipe 18 or the pipe body 18-1 and the other annular rib 20 is provided spaced a certain distance rearward from the one annular rib 22.

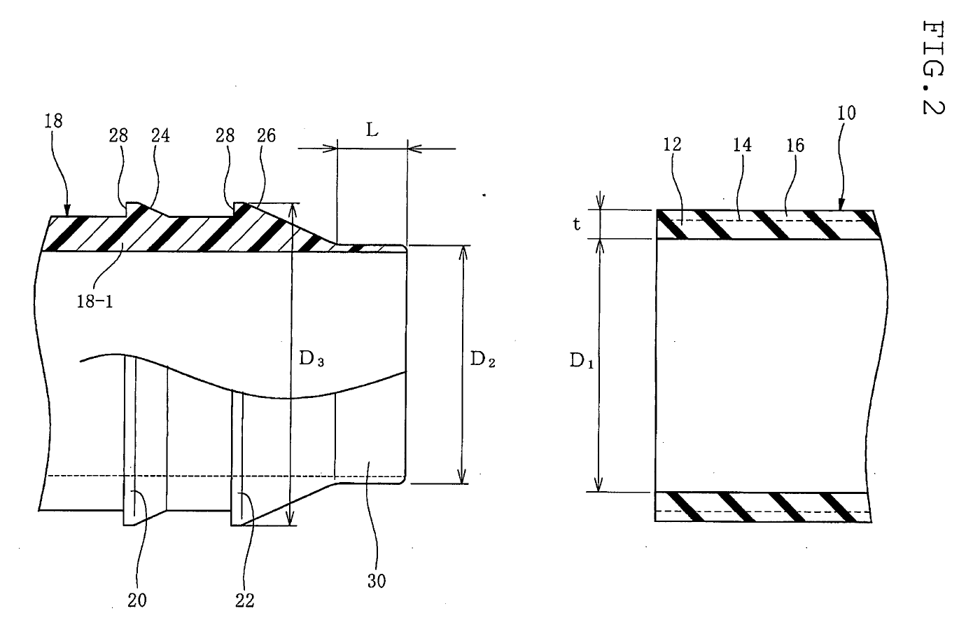

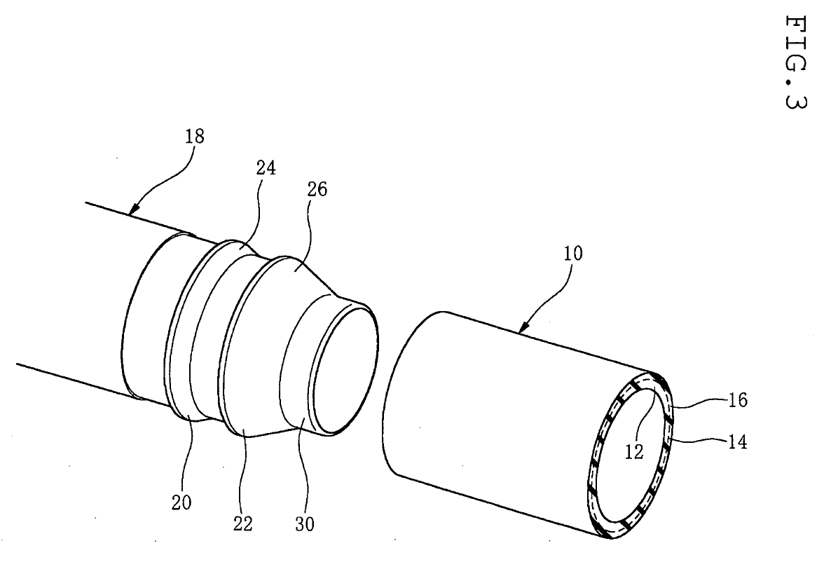

In these annular ribs 20, 22, as shown also in FIGS. 2 and 3, surfaces on a leading end thereof, namely surfaces on a press-fitted end thereof (front surfaces, surfaces facing a press-fitted direction, or surfaces facing forward) define tapered guide surfaces 24, 26 that serve as guide for the rubber hose 10 while the connecting pipe 18 is press-fitted in the rubber hose 10, and surfaces on a trailing end thereof (rear surfaces or surfaces facing rearward) define radial surfaces 28 extending from an outer peripheral surface of the connecting pipe 18 or the pipe body 18-1 in a direction perpendicular to an axis, namely in a radial direction.

Meanwhile, the tapered guide surfaces 24, 26 are inclined at generally the same angle relative to an axis or an axial direction.

In this embodiment, the connecting pipe 18 is formed integrally with a tubular support portion 30 on a leading end thereof beyond the one annular rib 22 of a leading end. Namely, the tubular support portion 30 is formed on a leading end of the pipe body 18-1 so as to be arranged on a leading end beyond the one annular rib 22. More specifically, the tubular support portion 30 is formed integrally on a leading edge of the pipe body 18-1. Here, the connecting pipe 18 comprises the pipe body 18-1, the annular ribs 20, 22 and the support portion 30.

The support portion 30 is a portion to serve to support the rubber hose 10 in a radially outer side from an inner surface side thereof, on a leading end beyond the annular rib 22 while the connecting pipe 18 is press-fitted in the rubber hose 10. As shown in FIG. 2, an outer diameter D₂ of the support portion 30 is designed equal to or smaller than an inner diameter D₁ of the rubber hose 10. The outer diameter D₂ may be designed slightly larger than the inner diameter D₁.

And, the support portion 30 is formed so as to project in an axial direction for a length L from the pipe body 18-1.

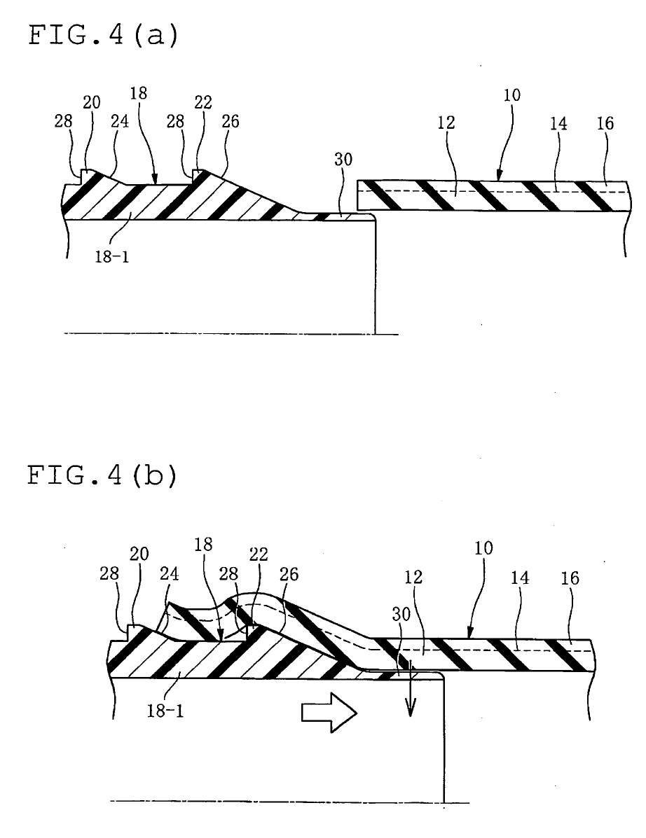

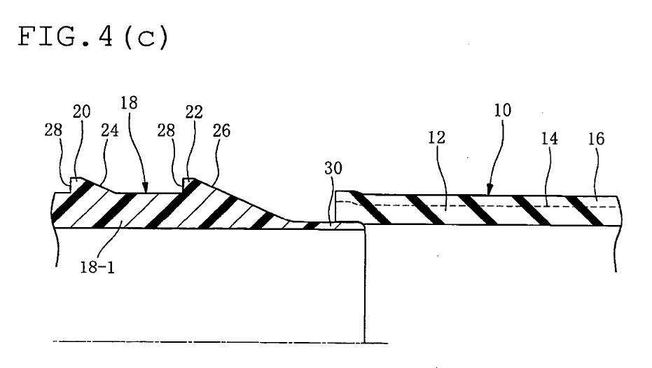

As well understood from FIG. 4, when the connecting pipe 18 is press-fitted in the rubber hose 10 in an axial direction, an end portion of the rubber hose 10 is diametrically enlarged, and thereby a tension or tightening force (resistance or resisting force) of the end portion of the rubber hose 10 to the connecting pipe 18 is created. The tension or tightening force and an action of the annular ribs 20, 22 biting in the inner surface of the rubber hose 10 provides the connecting pipe 18 with stop relative to the rubber hose 10. Namely, the connecting pipe 18 is securely fixed in the rubber hose 10 in a stopped relation.

When the connecting pipe 18 is press-fitted in the rubber hose 10, the tubular support portion 30 supports the rubber hose 10 radially outward from the inner surface side thereof on the leading end beyond the annular rib 22, and prevents the rubber hose 10 from being bent radially inward or in a radially inside direction. This function favorably prevents the rubber hose 10 from being buckled during press-fitting of the connecting pipe 18.

Meanwhile, although the rubber hose 10 includes a fiber reinforcing layer 14, the rubber hose 10 is preferably prevented from being buckled even in such case. And, instead of the fiber reinforcing layer 14 or as the fiber reinforcing layer 14, the rubber hose 10 may be provided with a reinforcing layer constructed by a reinforcing yarn therein. The reinforcing layer of the reinforcing yarn may be constructed by braiding or spirally winding a staple yarn, spunnized yarn or dip yarn. A braid angle or spirally winding angle (an angle of a yarn with respect to an axis) in this case may be in a range of 45° to 55°.

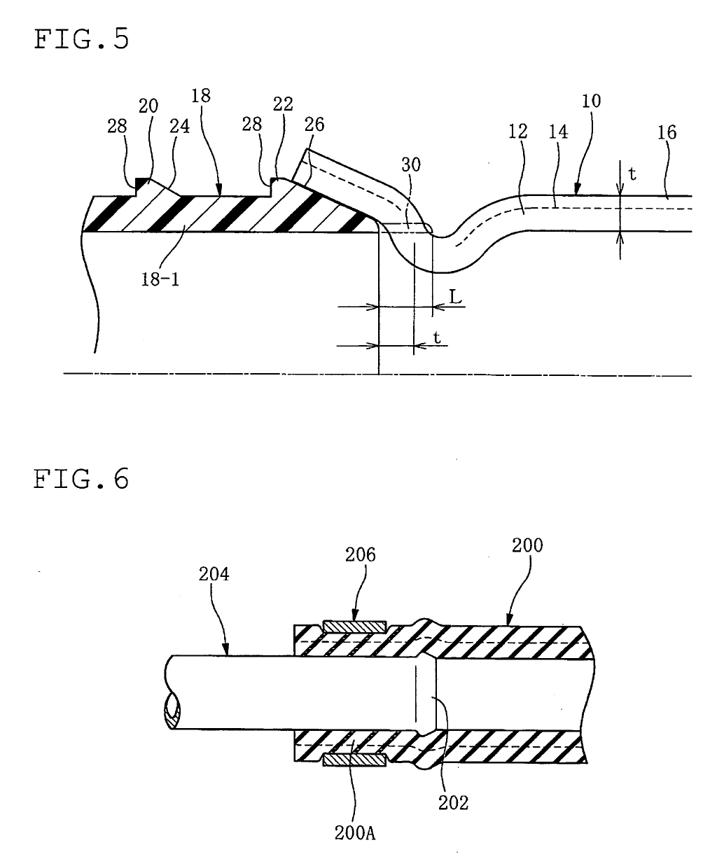

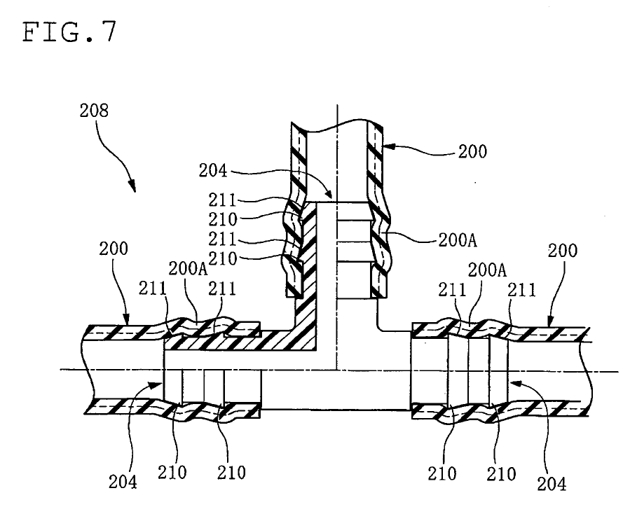

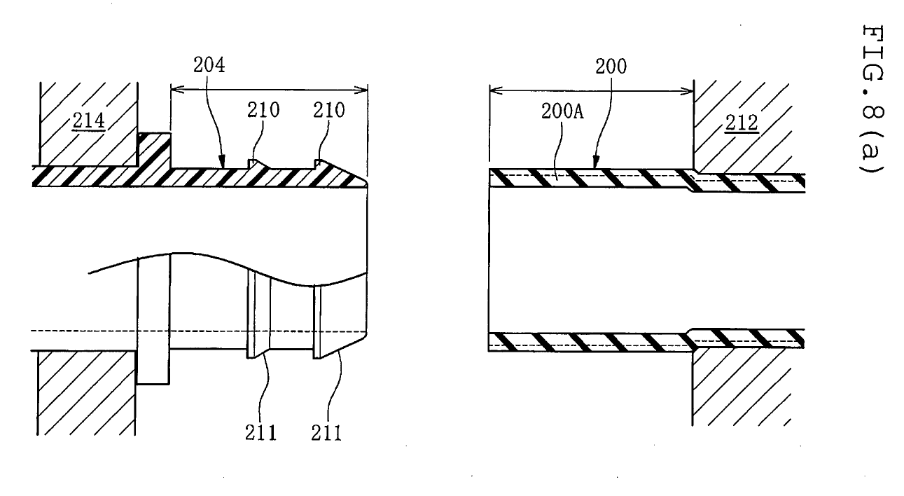

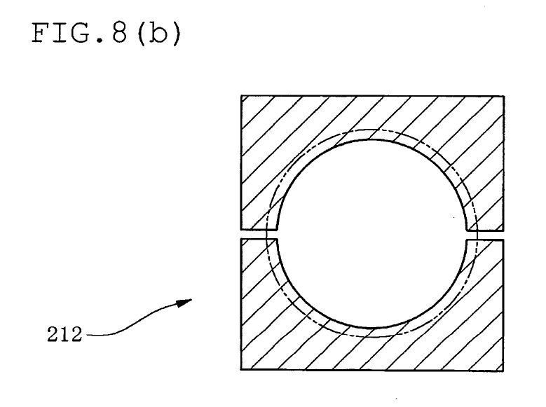

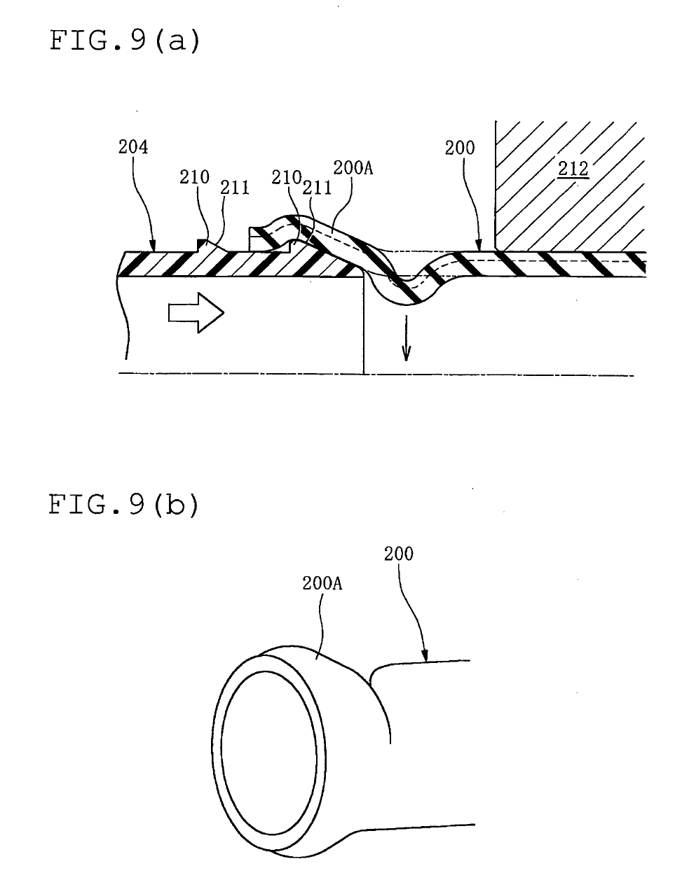

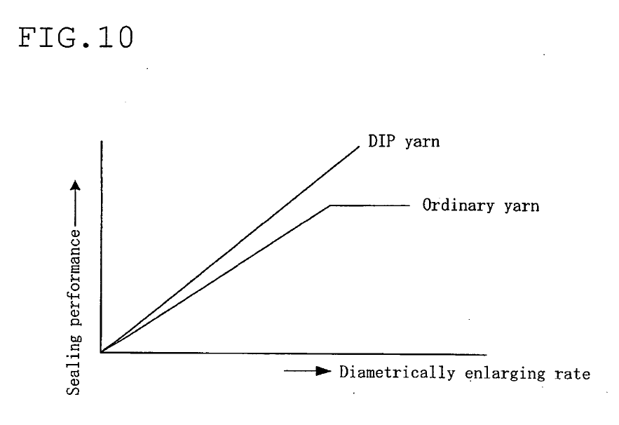

Here, it is effective to design the support portion 30 with a length (L in FIG. 2) equal to or greater than a wall-thickness t of the rubber hose 10 in view of effectively preventing buckling of the rubber hose 10 as shown in FIG. 5. However, the longer the support portion 30 is, the more stably the support portion 30 may exhibit a function of preventing the buckling of the rubber hose 10 (in FIG. 5, the outer diameter of the support portion 30 is designed larger than the inner diameter of the rubber hose 10).

Here, the projecting length L of the support portion 30 shown in FIG. 2 is 5 mm, while the wall-thickness t of the rubber hose 10 is 4 mm, and the inner diameter D₁ of the rubber hose 10 is 33 mm.

An outer diameter D₃ of each of the annular ribs 20, 22 is 44.5 mm,

In this connecting pipe 18, the outer diameter D₃ should be designed larger than the inner diameter D₁ of the rubber hose 10, namely has a relation of D₃>D₁.

And, in this embodiment, the outer diameter D₂ of the support portion 30 is constant along its entire length, 33 mm.

However, the outer diameter D₂ of the support portion 30 may be designed in a range of 33.2 mm to 34.0 mm (for example, 33.6 mm), larger than the inner diameter D₁ of the rubber hose 10. That is, the outer diameter D₂ may be designed larger than the inner diameter D₁, for example, by 0.2 mm to 1.0 mm. In this case, the end portion of the rubber hose 10 is diametrically enlarged slightly by the support portion 30 at start of press-fitting (refer to FIG. 4(c)).

According to the embodiment as stated above, as the rubber hose 10 is supported by the tubular support portion 30 from the inner surface side thereof when the connecting pipe 18 is press-fitted in the rubber hose 10 against its resisting force while diametrically enlarging an end portion of the rubber hose 10, the rubber hose 10 may be favorably prevented from being buckled, and thereby the connecting pipe 18 may be favorably press-fitted in the rubber hose 10.

Although the preferred embodiments have been described above, these are only some of embodiments of the present invention. The present invention may be constructed and embodied in various configurations and modes within the scope of the present invention.

What is claimed is:

1. A connecting pipe with rigidity to be securely fixed in a rubber hose by press-fitting, comprising:
a pipe body,
an annular rib provided at least on a leading end portion of the pipe body,
a tubular support portion formed on a leading end of the pipe body, the tubular support portion being arranged on a leading end beyond the annular rib,
wherein the annular rib has a generally saw-edged cross-section and is formed in an acute angled shape, the annular rib is provided with a guide surface on a leading and press-fitted end of the annular rib to guide the rubber hose during press-fitting, the annular rib serves as a stopper relative to the rubber hose by biting in an inner surface of the rubber hose, and
wherein the support portion supports the rubber hose in a radially outer side from an inner surface side thereof, on a leading end beyond the annular rib while being press-fitted in the rubber hose.

2. A connecting pipe with rigidity to be securely fixed in a rubber hose by press-fitting, the rubber hose being a large diameter rubber hose having an inner diameter larger than 16 mm, the connecting pipe, comprising:
a pipe body,
an annular rib provided at least on a leading end portion of the pipe body,
a tubular support portion formed on a leading end of the pipe body, the tubular support portion being arranged on a leading end beyond the annular rib,
wherein the annular rib has a generally saw-edged cross-section and is formed in an acute angled shape, the annular rib is provided with a guide lo surface on a leading and press-fitted end of the annular rib to guide the rubber hose during press-fitting, the annular rib serves as a stopper relative to the rubber hose by biting in an inner surface of the rubber hose, and
wherein the support portion supports the rubber hose in a radially outer side from an inner surface side thereof, on a leading end beyond the annular rib while being press-fitted in the rubber hose.

3. The connecting pipe as set forth in claim 1, wherein an outer diameter of the support portion is equal to or smaller than an inner diameter of the rubber hose.

4. The connecting pipe as set forth in claim 1, wherein an outer diameter of the support portion is larger than an inner diameter of the rubber hose.

5. The connecting pipe as set forth in claim 1, wherein the support portion projects in an axial direction for a length equal to or greater than a wall-thickness of the rubber hose.

6. The connecting pipe as set forth in claim 1, wherein the connecting pipe is press-fitted in the rubber hose and is securely fixed to the rubber hose not by a hose clamp, but only by press-fitting.

7. The connecting pipe as set forth in claim 1, wherein a staple yarn, a spunnized yarn or a dip yarn is provided as a reinforcing yarn in the rubber hose.

8. The connecting pipe as set forth in claim 2, wherein an outer diameter of the support portion is equal to or smaller than an inner diameter of the rubber hose.

9. The connecting pipe as set forth in claim 2, wherein an outer diameter of the support portion is larger than an inner diameter of the rubber hose.

10. The connecting pipe as set forth in claim 2, wherein the support portion projects in an axial direction for a length equal to or greater than a wall-thickness of the rubber hose.

11. The connecting pipe as set forth in claim 2, wherein the connecting pipe is press-fitted in the rubber hose and is securely fixed to the rubber hose not by a hose clamp, but only by press-fitting.

12. The connecting pipe as set forth in claim 2, wherein a staple yarn, a spunnized yarn or a dip yarn is provided as a reinforcing yarn in the rubber hose.
